(19) United States
(12) Patent Application Publication
(10) Pub. No.: US 2025/0090283 A1
(43) Pub. Date: Mar. 20, 2025

(54) ORTHODONTIC APPLIANCE RETENTION-ACTIVATION SYSTEMS AND METHODS

(71) Applicant: ALIGN TECHNOLOGY, INC., San Jose, CA (US)

(72) Inventors: Iman SHOJAEI, San Jose, CA (US); Eric YAU, Santa Clara, CA (US); John Y. MORTON, San Jose, CA (US)

(73) Assignee: ALIGN TECHNOLOGY, INC., San Jose, CA (US)

(21) Appl. No.: 18/890,537

(22) Filed: Sep. 19, 2024

Related U.S. Application Data
(60) Provisional application No. 63/583,906, filed on Sep. 20, 2023.

(51) Int. Cl. A61C 9/00; A61C 7/00

(52) U.S. Cl. CPC A61C 9/0046; A61C 2007/004

(57) ABSTRACT

A system for generating aligner shapes may include one or more processors and memory comprising instructions that when executed by the one or more processors, causes the system to carry out a method. The method may include determining a desired force system for moving a tooth, generating a population of sets of degrees of freedom and contact surfaces, determining a force system for each of the sets in the population evaluating a cost function of each of the force systems compared to the desired force system, updating the population of sets of degrees of freedom and contact surfaces based on the cost function of each of the force systems, and repeating determining a force system, evaluating a cost function and updating the population until the determined force system for one of the sets matches the desired force system, to generate a final set of degrees of freedom and contact surfaces.

### RELATED APPLICATIONS

This application claims the benefit under 35 U.S.C. § 119(e) of U.S. Provisional Patent Application No. 63/583,906, filed Sep. 20, 2023, and titled “ORTHODONTIC APPLIANCE RETENTION-ACTIVATION SYSTEMS AND METHODS,” which is incorporated, in its entirety, by this reference.

### BACKGROUND

The smooth and uniform surface of teeth can cause less than desirable results with some orthodontic tooth movement using aligners. The smooth surfaces introduce limitations for generating forces and movements in some directions. A lack of tooth surfaces normal to desired tooth movements for force application on a tooth and the small friction between the tooth and aligner causes less than desirable forces, moments, counter moments, and their corresponding translational and rotational movements. Movements are also less predictable than desired.

Many of these issues are thought to be caused by a lack of retention. Retention issue is aggravated when large gaps exist between the tooth and aligner surface. The gaps may be the result of shaping aligner to address patient comfort, manufacturing limitations, or other issues. A lack of retention is thought to inhibit large activation forces between the aligner and the teeth. As a result, corresponding energy and forces from the aligner are not be transferred to the tooth so that the aligner surfaces slip over the tooth, and the energy is relaxed. Attachments have been designed and used for many movements.

Attachments are less than desirable for many reasons, such as the time and expense to design, fabricate, and apply the attachments. Attachments may be visible on the teeth, leading to less than desirable aesthetics during treatment.

### SUMMARY

As will be described in greater detail below, the present disclosure describes various systems and methods for designing and fabricating aligners with increased activation and retention.

In addition, the systems and methods described herein may improve the functioning of a computing device by reducing computing resources and overhead for designing and fabricating aligners with increased activation and retention and for treatment planning, thereby improving processing efficiency of the computing device over conventional approaches. These systems and methods may also improve the field of dental treatment by designing and fabricating aligners with increased activation and retention to efficiently correct defects in patient's teeth.

### INCORPORATION BY REFERENCE

All patents, applications, and publications referred to and identified herein are hereby incorporated by reference in their entirety and shall be considered fully incorporated by reference even though referred to elsewhere in the application.

### BRIEF DESCRIPTION OF THE DRAWINGS

A better understanding of the features, advantages and principles of the present disclosure will be obtained by reference to the following detailed description that sets forth illustrative embodiments, and the accompanying drawings of which:

FIG. 1A illustrates an exemplary tooth repositioning appliance or aligner that can be worn by a patient in order to achieve an incremental repositioning of individual teeth in the jaw, in accordance with some embodiments.

FIG. 1B illustrates a tooth repositioning system, in accordance with some embodiments.

FIG. 2 shows a method of orthodontic treatment using a plurality of appliances, in accordance with embodiments;

FIG. 3 shows a method for digitally planning an orthodontic treatment, in accordance with embodiments; and

FIG. 4 shows a simplified block diagram of a data processing system, in accordance with embodiments.

FIG. 5 shows aspects of a method for designing a model for generating an appliance for imparting a desired force system with retention and activation, in accordance with some embodiments.

FIG. 6 shows aspects of a method for using the model developed in FIG. 5 for generating an appliance for imparting a desired force system with retention and activation, in accordance with some embodiments.

FIG. 7 shows a block diagram of an example machine-learning force system generating apparatus, in accordance with some embodiments.

FIG. 8 shows an example of an improved activation and retention force system, in accordance with some embodiments.

FIG. 9 shows an example location and size of a pressure point and a bubble for MDRC tooth movement of an incisor generated using the systems and methods described herein, in accordance with some embodiments.

FIG. 10 show a cross section of an aligner that can be worn by a patient in order to achieve an incremental repositioning of individual teeth in the jaw, in accordance with some embodiments.

### DETAILED DESCRIPTION

The following detailed description provides a better understanding of the features and advantages of the improvements described in the present disclosure in accordance with the embodiments disclosed herein. Although the detailed description includes many specific embodiments, these are provided by way of example only and should not be construed as limiting the scope of the inventions disclosed herein.

Described herein are systems and methods for treating patient's teeth using aligners designed using systems and methods for providing increased retention and activation of aligners when applied to a patient's dentition.

As described herein, solutions have been developed and validated to generate desired force systems in different directions even without attachments on patient's teeth. In some embodiments, a multi-directional retention activation method wherein six degrees of freedom (DoF) of aligner movement plus local contact surfaces of an aligner are designed together to generate a retention and force system. The methods described herein may determine the DoFs, their magnitude, the local contact surfaces, and an associated amount of penetration and/or relief on the aligner using machine learning-based modeling and optimization approaches. In some embodiments, methods are applied to several movements including mesial-distal movements with root control (MDRC) without attachments. Root control includes movements of teeth that reduce or address potential tipping of the teeth to provide a rotation or transition of the tooth without tipping or minimal tipping.

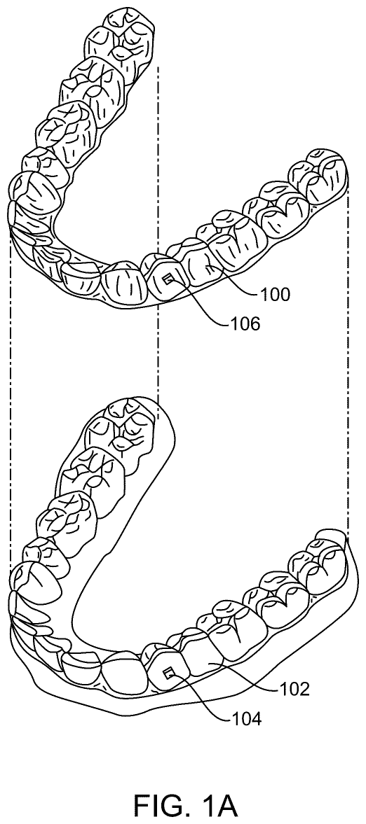

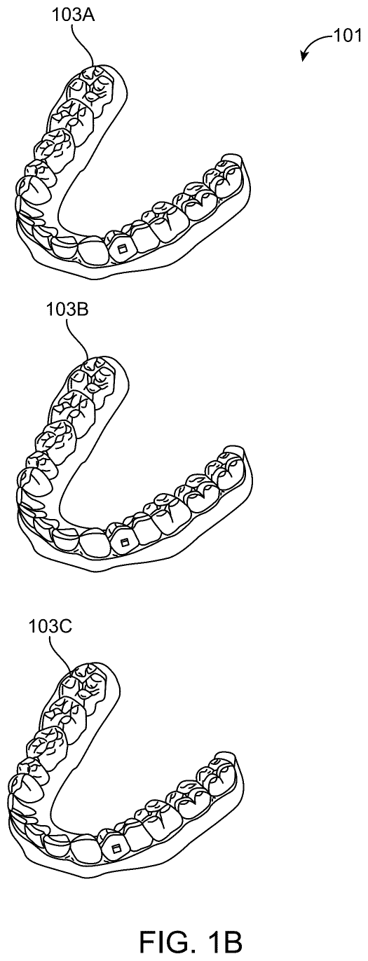

FIG. 1A illustrates an exemplary tooth repositioning appliance 100, such as an aligner that can be worn by a patient in order to achieve an incremental repositioning of individual teeth 102 in the jaw. The appliance can include a shell (e.g., a continuous polymeric shell or a segmented shell) having teeth-receiving cavities that receive and resiliently reposition the teeth. An appliance or portion(s) thereof may be indirectly fabricated using a physical model of teeth. For example, an appliance (e.g., polymeric appliance) can be formed using a physical model of teeth and a sheet of suitable layers of polymeric material. The physical model (e.g., physical mold) of teeth can be formed through a variety of techniques, including 3D printing. The appliance can be formed by thermoforming the appliance over the physical model. In some embodiments, a physical appliance is directly fabricated, e.g., using additive manufacturing techniques, from a digital model of an appliance. In some embodiments, the physical appliance may be created through a variety of direct formation techniques, such as 3D printing. An appliance can fit over all teeth present in an upper or lower jaw, or less than all of the teeth. The appliance can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance can be a generic appliance configured to receive the teeth, but not necessarily shaped to match the topography of the patient's teeth. In some cases, only certain teeth received by an appliance will be repositioned by the appliance while other teeth can provide a base or anchor region for holding the appliance in place as it applies force against the tooth or teeth targeted for repositioning. In some cases, some or most, and even all, of the teeth will be repositioned at some point during treatment. Teeth that are moved can also serve as a base or anchor for holding the appliance as it is worn by the patient. In some embodiments, no wires or other means will be provided for holding an appliance in place over the teeth. In some cases, however, attachments or other anchoring elements 104 on teeth 102 with corresponding receptacles or apertures 106 in the appliance 100 so that the appliance can apply a selected force on the tooth. Exemplary appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the URL “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

The present disclosure provides an improved aligner design that may reduce, replace, or eliminate the use of such attachments during orthodontic treatment.

FIG. 1B illustrates a tooth repositioning system 101 including a plurality of appliances 103A, 103B, 103C. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 101 can include a first appliance 103A corresponding to an initial tooth arrangement, one or more intermediate appliances 103B corresponding to one or more intermediate arrangements, and a final appliance 103C corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

Optionally, in cases involving more complex movements or treatment plans, it may be beneficial to utilize auxiliary components (e.g., features, accessories, structures, devices, components, and the like) in conjunction with an orthodontic appliance. Examples of such accessories include but are not limited to elastics, wires, springs, bars, arch expanders, palatal expanders, twin blocks, occlusal blocks, bite ramps, mandibular advancement splints, bite plates, pontics, hooks, brackets, headgear tubes, springs, bumper tubes, palatal bars, frameworks, pin-and-tube apparatuses, buccal shields, buccinator bows, wire shields, lingual flanges and pads, lip pads or bumpers, protrusions, divots, and the like. In some embodiments, the appliances, systems and methods described herein include improved orthodontic appliances with integrally formed features that are shaped to couple to such auxiliary components, or that replace such auxiliary components.

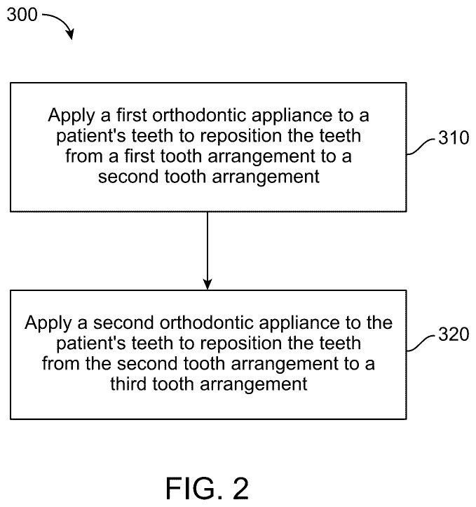

FIG. 2 illustrates a method 200 of orthodontic treatment using a plurality of appliances, in accordance with many embodiments. The method 200 can be practiced using any of the appliances or appliance sets described herein. In step 210, a first orthodontic appliance is applied to a patient's teeth in order to reposition the teeth from a first tooth arrangement to a second tooth arrangement. In step 220, a second orthodontic appliance is applied to the patient's teeth in order to reposition the teeth from the second tooth arrangement to a third tooth arrangement. The method 200 can be repeated as necessary using any suitable number and combination of sequential appliances in order to incrementally reposition the patient's teeth from an initial arrangement to a target arrangement. The appliances can be generated all at the same stage or in sets or batches (e.g., at the beginning of a stage of the treatment), or one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable in order to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied in order to compensate for any inaccuracies or limitations of the appliance.

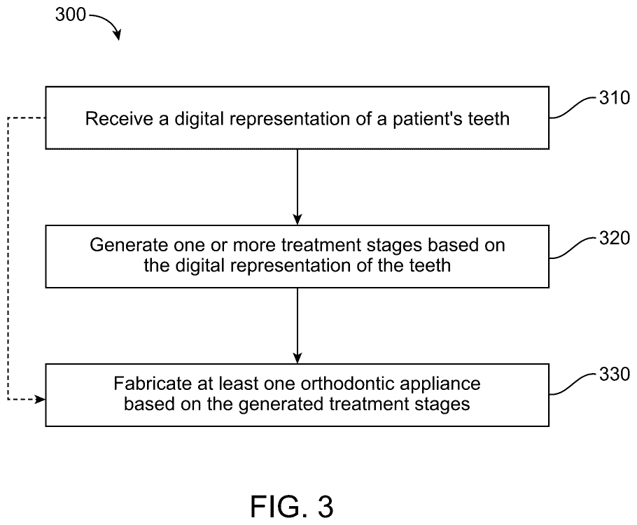

FIG. 3 illustrates a method 300 for digitally planning an orthodontic treatment and/or design or fabrication of an appliance, in accordance with many embodiments. The method 300 can be applied to any of the treatment procedures described herein and can be performed by any suitable data processing system. Any embodiment of the appliances described herein can be designed or fabricated using the method 300.

In step 310, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In step 320, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In step 330, at least one orthodontic appliance is fabricated based on the generated treatment stages. For example, a set of appliances can be fabricated to be sequentially worn by the patient to incrementally reposition the teeth from the initial arrangement to the target arrangement. Some of the appliances can be shaped to accommodate a tooth arrangement specified by one of the treatment stages. Alternatively or in combination, some of the appliances can be shaped to accommodate a tooth arrangement that is different from the target arrangement for the corresponding treatment stage. For example, as previously described herein, an appliance may have a geometry corresponding to an overcorrected tooth arrangement. Such an appliance may be used to ensure that a suitable amount of force is expressed on the teeth as they approach or attain their desired target positions for the treatment stage. As another example, an appliance can be designed in order to apply a specified force system on the teeth and may not have a geometry corresponding to any current or planned arrangement of the patient's teeth.

In some instances, staging of various arrangements or treatment stages may not be necessary for design and/or fabrication of an appliance. As illustrated by the dashed line in FIG. 3, design and/or fabrication of an orthodontic appliance, and perhaps a particular orthodontic treatment, may include use of a representation of the patient's teeth (e.g., receive a digital representation of the patient's teeth 310), followed by design and/or fabrication of an orthodontic appliance based on a representation of the patient's teeth in the arrangement represented by the received representation.

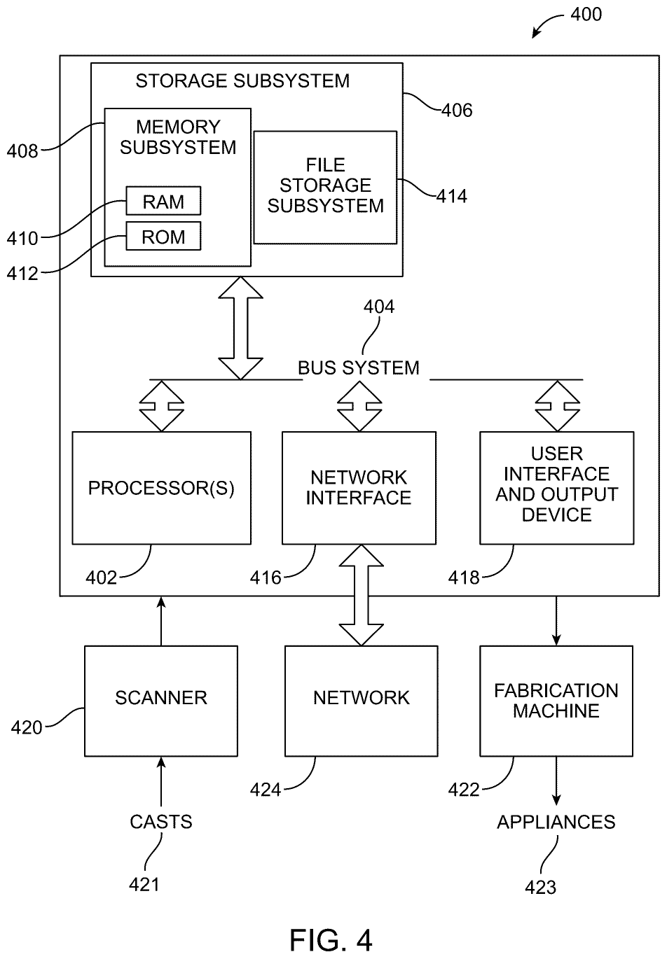

FIG. 4 is a simplified block diagram of a data processing system 1400 that may be used in executing methods and processes described herein. The data processing system 400 typically includes at least one processor 402 that communicates with one or more peripheral devices via bus subsystem 404. These peripheral devices typically include a storage subsystem 406 (memory subsystem 408 and file storage subsystem 414), a set of user interface input and output devices 418, and an interface to outside networks 416. This interface is shown schematically as “Network Interface” block 416, and is coupled to corresponding interface devices in other data processing systems via communication network interface 424. Data processing system 400 can include, for example, one or more computers, such as a personal computer, workstation, mainframe, laptop, and the like.

The user interface input devices 418 are not limited to any particular device, and can typically include, for example, a keyboard, pointing device, mouse, scanner, interactive displays, touchpad, joysticks, etc. Similarly, various user interface output devices can be employed in a system of the invention, and can include, for example, one or more of a printer, display (e.g., visual, non-visual) system/subsystem, controller, projection device, audio output, and the like.

Storage subsystem 406 maintains the basic required programming, including computer readable media having instructions (e.g., operating instructions, etc.), and data constructs. The program modules discussed herein are typically stored in storage subsystem 406. Storage subsystem 406 typically includes memory subsystem 408 and file storage subsystem 414. Memory subsystem 408 typically includes a number of memories (e.g., RAM 410, ROM 412, etc.) including computer readable memory for storage of fixed instructions, instructions and data during program execution, basic input/output system, etc. File storage subsystem 414 provides persistent (non-volatile) storage for program and data files, and can include one or more removable or fixed drives or media, hard disk, floppy disk, CD-ROM, DVD, optical drives, and the like. One or more of the storage systems, drives, etc. may be located at a remote location, such coupled via a server on a network or via the internet/World Wide Web. In this context, the term “bus subsystem” is used generically so as to include any mechanism for letting the various components and subsystems communicate with each other as intended and can include a variety of suitable components/systems that would be known or recognized as suitable for use therein. It will be recognized that various components of the system can be, but need not necessarily be at the same physical location, but could be connected via various local-area or wide-area network media, transmission systems, etc.

Scanner 420 includes any means for obtaining a digital representation (e.g., images, surface topography data, etc.) of a patient's teeth (e.g., by scanning physical models of the teeth such as casts 421, by scanning impressions taken of the teeth, or by directly scanning the intraoral cavity), which can be obtained either from the patient or from treating professional, such as an orthodontist, and includes means of providing the digital representation to data processing system 400 for further processing. Scanner 420 may be located at a location remote with respect to other components of the system and can communicate image data and/or information to data processing system 400, for example, via a network interface 424. Fabrication system 422 fabricates appliances 423 based on a treatment plan, including data set information received from data processing system 400. Fabrication machine 422 can, for example, be located at a remote location and receive data set information from data processing system 400 via network interface 424.

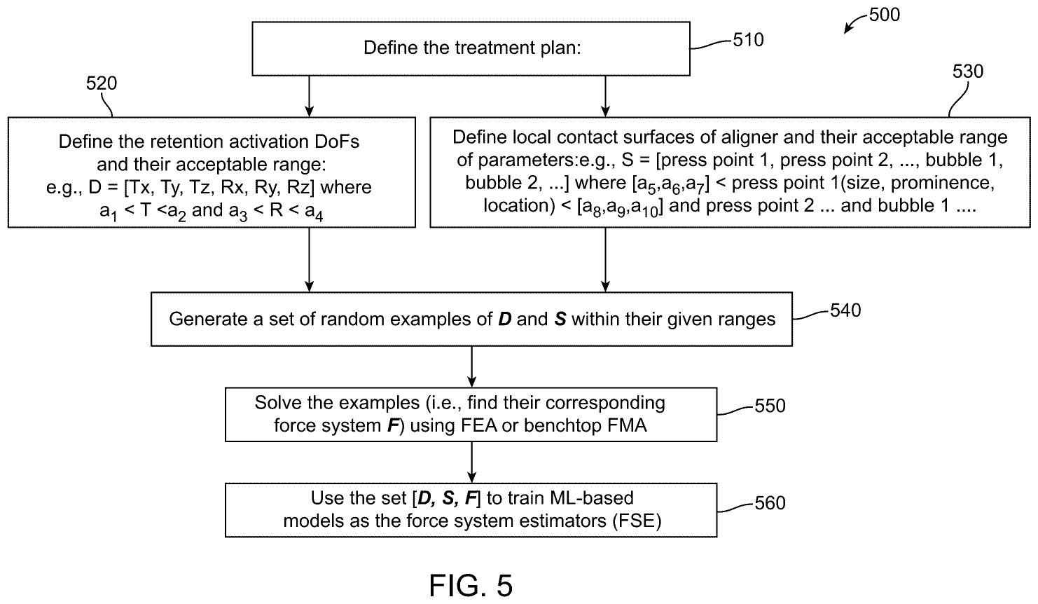

FIG. 5 shows aspects of a method 500 for designing a model for generating an appliance for imparting a desired force system with retention and activation.

Method 500 may include defining a treatment plan at block 510, defining retention and activation DoFs and their range at block 520, defining local contact surfaces of an aligner and their ranges at block 530, generating a set of random examples of DoFs and contact surfaces at block 540, solving the examples to determine a resulting force system at block 550, generating force system estimator that includes a machine learning based model trained on the set of DoFs, local contact surfaces, and resulting force systems at block 560. The training data may include numerical simulations of aligners applied to teeth and having defined retention and activation DoFs, defined contact surfaces, and simulated resultant forces. In some embodiment, training data may include physical testing, such as measured forces of physical aligners applied to teeth or a teeth fixture, such as a physical model of teeth, wherein the physical aligners are generated based on defined retention and activation DoFs and defined contact surfaces. In some embodiments, the training data may include a combination of simulations, such as numerical simulations, and physical testing.

The method 500 may be used to generate a generic model, such as based on average or representative tooth sizes, shapes, etc for a particular demographic. The demographic may be all people, people of a particular age or age range, sex, with a particular malocclusion, such as a class II or class III malocclusion. In some embodiments, the method may be used for a particular patient. In some embodiments, the method may be used to generate a model for each stage of a treatment plan for a particular patient.

At block 510 a treatment plan is defined. The treatment plan may include one or more tooth movements. The tooth movement or movements may be for a particular stage of a treatment plan, a particular tooth, etc. For example, the treatment plan may be lateral mesial-distal movement with root control (MDRC) of a central or lateral incisor.

At block 520 retention and activation DoFs and their ranges are defined. The degrees of freedom may be three-dimensional translation and three dimensional rotation. The set of degrees of freedom for activation and for retention may be represented by D.

D=[Tₓ,T_{y},T_{z},Rₓ,R_{y},R_{z}]

Tx, Ty, and Tz and are translational degrees of freedom along three orthogonal axis x, y, and z. Similarly, Rx, Ry, and Rz, are the rotational degrees of freedom about the three orthogonal axis, z, y, and z. In some embodiments, less than all six degrees of freedom may be used for activation and/or retention. For example, activation may use one set or subset of the six degrees of freedom and retention can use a different set or subset of the six degrees of freedom. In some embodiments, the degrees of freedom for activation include degrees of freedom also used for retention and vise-a-versa. In some embodiments, the degrees of freedom for activation do not include degrees of freedom used for retention and vise-a-versa. In some embodiments, the retention and activation degrees of freedom may each be limited to three degrees of freedom.

In some embodiments, such as, for example, MDRC, T_{z} (intrusion) can be used as a retention degree of freedom while T_{y} (mesial-distal movement) and Rₓ (angulation) can be used as activation degrees of freedom.

In some embodiments, the range for the translation degrees of freedom, which is the magnitude of the tooth translation movements for a given degree of freedom may be between 0 mm and 0.25 mm or between 0 mm and 1 mm. In some embodiments, the range for the rotational degrees of freedom, which is the magnitude of the tooth rotation for a given degree of freedom may be between 0 and 5 degrees. In some embodiments, the range may be a range around a planned movement magnitude for a stage of movement. Such as, the planned translational or rotational movement plus or minus 10% or 20%. The translation and rotation range for each degree of freedom may be within a range, such as a range between a lower bound a₁, a₃ and an upper bound a₂, a₄.

At block 530 local contact surfaces of an aligner and their ranges are defined. The local contract surfaces of the aligner may be defined by a number of bubbles and pressure points and range of parameters for each pressure point or bubble. A pressure point is a location where a surface of a mold or tooth surface is subtracted from or otherwise modified such that a sidewall of a tooth receiving cavity protrudes inward towards the tooth while a bubble is a location where a surface of a mold or tooth surface is added to or otherwise modified such that a sidewall of a tooth receiving cavity protrudes outward, away from the tooth. The set of contact points may be represented by S.

S=[press point 1,press point 2, . . . ,bubble1,bubble2, . . . ]

Where press point 1, bubble 1, etc. represent defined pressure points and bubbles. In some embodiments, one pressure point and one bubble are defined. In some embodiments, more than one pressure point and bubble are defined. In some embodiments, up to four pressure points and bubbles are defined.

Each pressure point and bubble may be defined by a size, prominence, location, and other characteristics, such as a geometric characteristics. The size may be a function of the tooth surface size, such as a percentage of the tooth surface, such as the buccal or lingual tooth surface. In some embodiments, the percentage may by less than 10%. In some embodiments, the percentage may be up to 100%. In some embodiments, the percentage may be between 5% and 25% of the tooth surface area. In some embodiments, the size may be between 5% and 100% of a tooths length and/or width. In some embodiments, the size may be an absolute size, such as between 2 square millimeters and 25 square millimeters. The prominence for a bubble may be the distance the bubble of the aligner extends away or out of the tooth receiving cavity and prominence for a pressure point may be a distance the pressure point of the aligner extends into the tooth receiving cavity from an unmodified tooth receiving cavity surface. In some embodiments, the prominence can be in a range of between 0.1 mm to 0.7 mm. In some embodiments, the prominence may be in the range of 0.1 mm to 1.0 mm. In some embodiments, the geometric characteristic may be an aspect ratio of the shape of the pressure point of bubble. An aspect ratio may be a length to width ratio, such as the length and width of a rectangle or a major and minor axis of an ellipse. The corners of a rectangle may be rounded. The characteristics may be within a range, such as a range between a lower bound of each characteristic, a₅, a₆, a₇, and an upper bound a₈, a₉, a₁₀.

The location may include a side of a tooth, such as a buccal or lingual side of a tooth, an occlusal surface of a tooth, and/or a two dimensional coordinate location on a tooth, such as a percentage of the mesial-distal width and a percentage of coronal-gingival height of a side or surface of a tooth. In some embodiments, 0% may be a most mesial or most gingival location while 100% may be a most distal or coronal location.

At block 540 a set of random examples of DoFs and contact surfaces are generated. In some embodiments, a set of random contact surfaces, such as bubbles and pressure points, are generated based on the D and S and their corresponding ranges and attributes are generated. In some embodiments, at least 1000 sets of contact surfaces are generated. In some embodiments, at least 500 sets of contact surfaces are generated.

At block 550 a resulting force system is determined for each of the random examples generated at block 550. For each set, a resulting force system is determined. The force system may be determined based on a finite element analysis of an aligner having the set of contact surfaces. In some embodiments, an aligner may be produced based on the set and used in a force measurement apparatus (FMA), which may be a dental arch with transducers, such as force sensors installed to artificial teeth onto which aligners can be engaged, to determine the resulting force on the tooth. The forces and moments produced by the aligner appliance are measured and charted for evaluation.

At block 560 a force system estimator is configured. The force system estimator which may include a machine learning based model trained on the sets of DoFs, local contact surfaces, and resulting force systems. A force system estimator may be based on the sets of contact surfaces determined at block 540 and their resulting force systems determined at block 550.

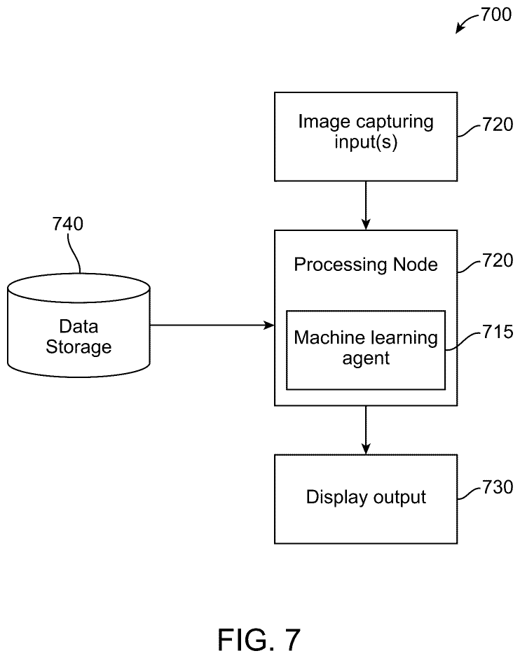

FIG. 7 schematically illustrates one example of a machine-learning force system generation apparatus 700 and may carry out the process of block 560. Although described herein as a system, the machine-learning force system generation apparatus 700 may be realized with any feasible apparatus, e.g., device, system, etc., including hardware, software, and/or firmware. In some examples the machine-learning force system generation apparatus 700 may include a processing node 710, a data generation or input device 720, a display output and/or device 730, and a data storage 740. As shown, the data generation or input device 720, the display output 130, and the data storage 140 may each be coupled to the processing node 710. In some examples, all components of the machine-learning force system generation apparatus 700 may be realized as a single device (e.g., within a single housing). In some other examples, components of the machine-learning force system generation apparatus 700 may be distributed within separate devices. For example, the coupling between any two or more devices, nodes, and or data storage (which may be referred to herein as modules) may be through a network, including the Internet. In some examples, the machine-learning force system generation apparatus 700 may be a cloud-based apparatus. In some examples one or more components of the machine-learning force system generation apparatus 700 may be cloud-based modules coupled together through any feasible wired or wireless network, including the internet.

The data generation or input device 720 may include one or more systems for carrying out the actions described in blocks 510, 520, 530, 540, and/or 550.

The display output 730 may be any feasible display output. In some examples, the display output 730 may be an integral part of the machine-learning force system generation apparatus 700 and be integrated into a common housing or case. In other examples, the display output 730 may be communicatively coupled to the machine-learning force system generation apparatus 700 through, for example, wired or wireless connections. In some cases, the display output 730 may include or may be configured to communicate with a computer monitor, tablet device, mobile phone, or the like. The display output 730 may be used to display data, such as data generated at blocks 510, 520, 530, 540, and/or 550.

The data storage 740 may be any feasible data storage including random access memory, solid state memory, disk-based memory, non-volatile memory, and the like. The data storage 740 may store data, such as data generated at blocks 510, 520, 530, 540, and/or 550.

The data storage 740 and/or the processing node may also include a non-transitory computer-readable storage medium that may store instructions that may be executed by the processing node 710. For example, the processing node 710 may include one or more processors that may execute instructions stored in the data storage device 740 to perform any number of operations including processing data from input 720 and generating a force system estimator machine learning model. For example, the data storage 740 may store one or more neural networks that may be trained and/or executed by the processing node 710. Alternatively, the processing node may include one or more machine-learning trained systems (e.g., trained neural networks, as descried herein) 715, as shown in FIG. 7.

In some examples, the data storage 740 may include instructions to train one or more neural networks to estimate force systems, as discussed herein. Additionally, or alternatively, the data storage device 740 may include instructions to execute one or more neural networks to estimate force systems on teeth.

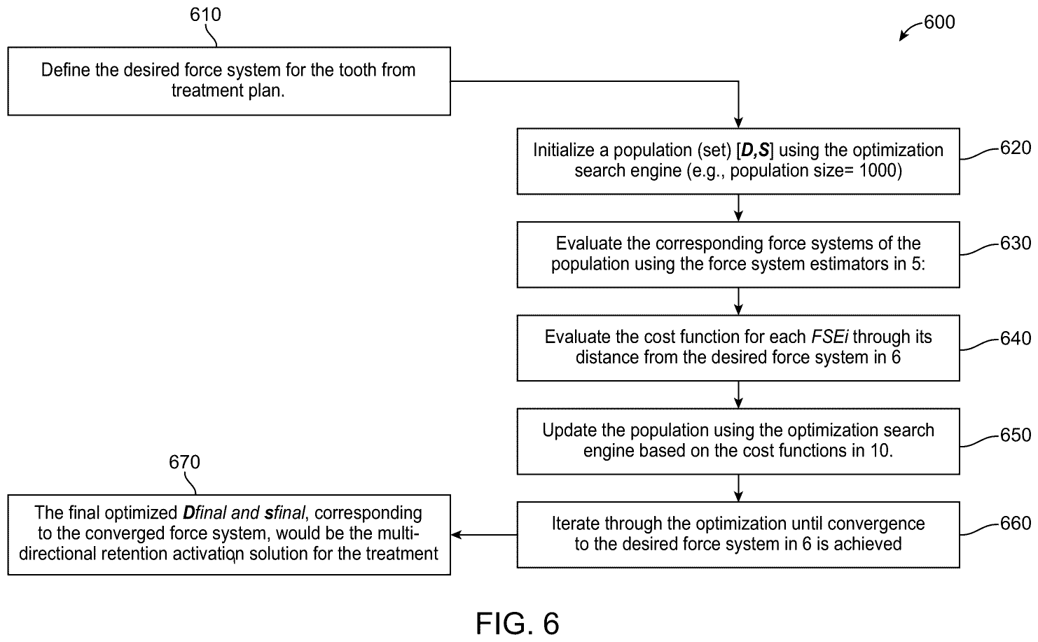

FIG. 6 shows aspects of a method 600 for using the model developed accordingly to the method 500 in FIG. 5 for generating an appliance for imparting a desired force system with retention and activation.

Method 600 may include defining a desired force system for a tooth or teeth at block 610, initializing a population set of D and S at block 620, evaluating resulting force systems from the population set of D and S at block 630, evaluating a cost function for reach force system at block 640, updating the population at block 650, iterating through blocks 630, 640, and 650 until the estimated force system converges to the desired force system at block 660, and output the determined D_{final} and S_{final} at block 670;

At block 610 a desired force system for a tooth is defined. This information may come from an orthodontic treatment plan, clinical knowledge, and/or empirical studies. An orthodontic treatment plan, such as described herein, may include force systems for moving each tooth. The force systems may include a force or force range and a moment or moment range for moving and/or rotating each tooth for each stage of an orthodontic treatment for a patient. The force system may be a single translational force for translating the tooth and/or a single rotational force for rotating the tooth.

At block 620 a population set of D and S is initialized. A set of random D and S generated. In some embodiments, 1000 random retention and activation DoFs may be generated. The degrees of freedom may be three-dimensional translation and three dimensional rotation. The set of degrees of freedom for activation and for retention may be represented by D.

In some embodiments, less than all six degrees of freedom may be used for activation and/or retention. For example, activation may use one set or subset of the six degrees of freedom and retention can use a different set or subset of the six degrees of freedom. In some embodiments, the degrees of freedom for activation include degrees of freedom also used for retention and vise-a-versa. In some embodiments, the degrees of freedom for activation do not include degrees of freedom used for retention and vise-a-versa. In some embodiments, the retention and activation degrees of freedom may each be limited to three degrees of freedom.

A set of contact points may be represented by S may be generated. The local contact surfaces of the aligner may be defined by a number of bubbles and pressure points and range of parameters for each pressure point or bubble. A pressure point is a location where a surface of a mold or tooth surface is subtracted from or otherwise modified such that a sidewall of a tooth receiving cavity protrudes inward towards the tooth while a bubble is a location where a surface of a mold or tooth surface is added to or otherwise modified such that a sidewall of a tooth receiving cavity protrudes outward, away from the tooth.

At block 630 the resulting force systems from the population set of D and S are determined. The machine learning model generated with process 500 may be used to determine the resulting force system on the tooth for each member of the population of D and S generated at block 620.

At block 640 a cost function for each force system is determined. The cost system for the resulting estimated force determined at block 630 for each D and S is determined. A cost function, also known as a loss function or an objective function, is a mathematical function used to quantify how well a model's predictions or outcomes match the actual values. At block 640 the cost function for each force system is determined based on how closely it matches the desired force system.

The goal of using the cost function is to evaluate how accurate the force from each D and S is compared to the desired force and to guide the process of adjusting the D and S in the next iteration to improve the accuracy of the resulting forces. In some embodiments, a Mean Squared Error (MSE) cost function is used. A MSE cost function calculates the average squared difference between the estimated force and the desired force.

At block 650 the population set of D and S is updated. In some embodiments, the population set of D and S is updated based on the D and S cost functions determined at block 640. For example, the updated population set of D and S may be based on the 10% of the D and S population generated at block 620 with the lost cost function determined at block 640. A new population, such as 1000 new D and S may be determined based on the 10% of D and S with the lowest cost functions.

At block 660 the process iterates through blocks 630, 640, and 650 until the estimated force system converges to the desired force system. With each iteration, a new population of D and S is generated, the resultant force system estimated for reach set of D and S, and the cost function of the D and S is determined. The process may iterate until a D and S is determined to result in a force system within a threshold of the cost function or within a threshold of the desired force system.

At block 670 the determined D_{final} and S_{final} is output. The D_{final} and S_{final} are the retention and activation degrees of freedom and the local contact surfaces of the aligner that produce the desired force system. Based on the D_{final} and S_{final} an orthodontic appliance may be generated and fabricated. For example, a digital model of the three-dimensional geometric shape of the aligner may be generated for use in fabrication, such as direct fabrication of an aligner having the three-dimensional geometric shape. In some embodiments, a mold for use in thermoforming orthodontic appliance may be generated D_{final} and S_{final}. The three-dimensional geometric shape of the mold or aligner may be output for fabrication. In some embodiments, instructions for fabricating an aligner may be output. The instructions may be output to a fabrication machine for fabricating the aligner, such as by direct fabrication of the aligner or fabrication of a mold and then fabrication of the aligner using the mold, such as by thermoforming. The mold and/or the aligner may then be fabricated by the appropriate fabrication process using a fabrication machine or machines.

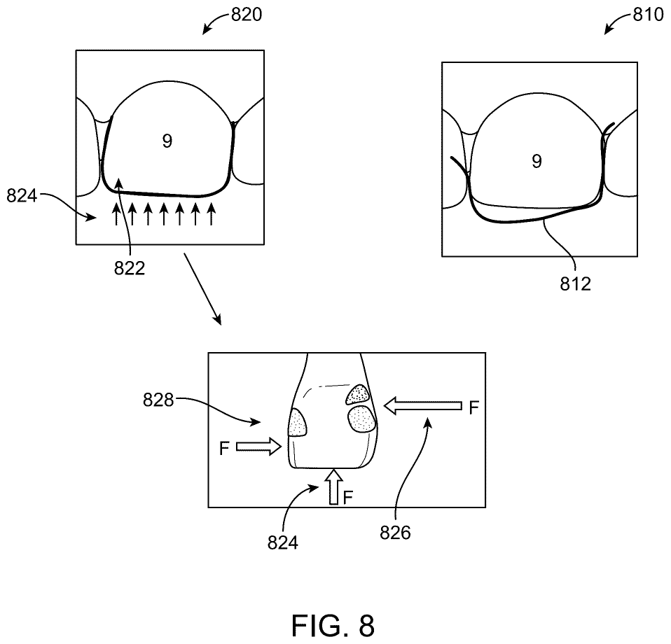

FIG. 8 shows an example of an improved activation and retention force system generated using the above systems and methods that improves retention on the tooth and thereby allows for greater activation (tooth movement) forces. In prior systems, wherein the forces are applied in the direction of desired tooth movement with possible additional forces to reduce tipping, the aligner 812 is not retained on the tooth. The activation forces may cause the aligner to deform in such a way that it slips off the patient's teeth. For example, an aligner may be shaped to impart a translational force 826 at a lower portion of a tooth crown. The translational force may also cause tipping of the tooth because it may be applied a distance from the center of resistance or rotation of the tooth. A second force 828 may be applied to the tooth crown a distance from the center of resistance or rotation of the tooth that is greater than the distance of the translations force 826. The magnitude of the second force 828 may be less than that of the translational force.

The system 820 developed using the processes describe herein generates an additional force 824 that is an intrusion force which aids in retaining the aligner 822 on the tooth and allows the activation force, the translational movement force, to be properly applied to the tooth. The intrusion force may be insufficient to intrude or actually move the tooth in an intrusion direction. Instead the instruction force may be a retention force that aids in retaining the aligner on the tooth.

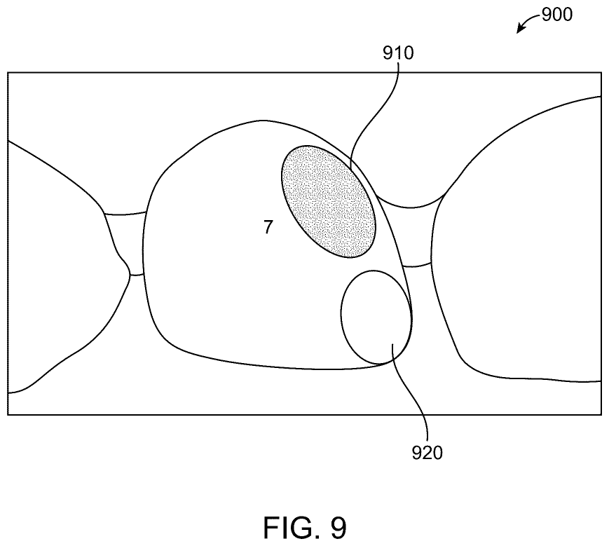

FIG. 9 shows an example location and size of a pressure point 910 and a bubble 920 for generating a force system for MDRC tooth movement of an incisor generated using the systems and methods described herein to determine a shape of an aligner. The pressure point 910 is located more gingivally on the crown than the bubble 920. The retention DoF determined using the methods described herein was Tz (intrusion) with a value of between 0.05 mm to 1 mm per stage. The activation DoFs determined using the methods described herein were Ty (mesial-distal movement, ranging from 0.05 mm to 0.6 mm per stage) and Rx (angulation, ranging from 2 degrees to 15 degrees per stage.

The resulting contact surfaces of the aligner were bubbles and pressure points 20-80% of the tooth width and length and prominences on the aligner of between 0.1 mm and 0.8 mm. Pressure point locations of the aligner were on buccal and lingual surfaces and bubbles were on the occlusal surfaces. The pressure points and bubbles may be formed as part of a tooth receiving cavity, such as in the walls of the tooth receiving cavies of an aligner.

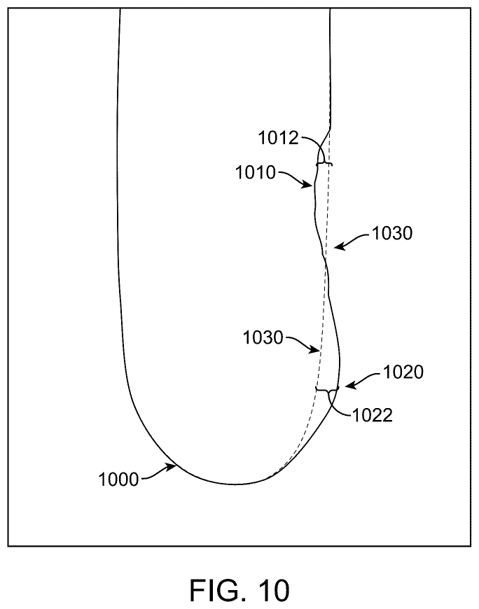

FIG. 10 depicts a cross section of an aligner 1000, which may have some or all of the features of aligners described herein, through a pressure point location and a bubble location, for example, as depicted in FIG. 9. As discussed herein, the prominence for a bubble 1020 may be a distance 1012 the bubble of the aligner 1000 extends away or out of the tooth receiving cavity from an unmodified tooth receiving cavity surface (such as in a direction normal to the tooth surface) and prominence for a pressure point may be a distance the pressure point of the aligner extends into the tooth receiving cavity from an unmodified tooth receiving cavity surface (such as in a direction normal to the tooth surface).

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and shall have the same meaning as the word “comprising.

The processor as disclosed herein can be configured with instructions to perform any one or more steps of any method as disclosed herein.

It will be understood that although the terms “first,” “second,” “third”, etc. may be used herein to describe various layers, elements, components, regions or sections without referring to any particular order or sequence of events. These terms are merely used to distinguish one layer, element, component, region or section from another layer, element, component, region or section. A first layer, element, component, region or section as described herein could be referred to as a second layer, element, component, region or section without departing from the teachings of the present disclosure.

As used herein, the term “or” is used inclusively to refer items in the alternative and in combination.

As used herein, characters, such as numerals, refer to like elements.

The present disclosure includes the following numbered clauses.

Clause 1. A method of generating orthodontic aligner shapes, the method comprising: determining a desired force system for moving a tooth; generating a population of sets of degrees of freedom and contact surfaces; determining a force system for each of the sets in the population evaluating a cost function of each of the force systems compared to the desired force system; updating the population of sets of degrees of freedom and contact surfaces based on the cost function of each of the force systems; and repeating (c) through (e) until the determined force system for one of the sets matches the desired force system, to generate a final set of degrees of freedom and contact surfaces.

Clause 2. The method of clause 1, wherein the force system is based on a movement of a tooth in a stage of an orthodontic treatment plan.

Clause 3. The method of clause 2, wherein the movement is rotation.

Clause 4. The method of clause 2, wherein the movement is translation.

Clause 5. The method of clause 1, wherein the degrees of freedom are activation degrees of freedom.

Clause 6. The method of clause 5, wherein the degrees of freedom are retention degrees of freedom.

Clause 7. The method of clause 6, wherein the degrees of freedom for retention are different than the degrees of freedom for retention.

Clause 8. The method of clause 7, wherein the degrees of freedom are selected from three rotational degrees of freedom about three orthogonal axis and three translations degrees of freedom along the three orthogonal axis.

Clause 9. The method of clause 8, wherein a range of translation in the translation degrees of freedom is between 0.05 mm and 1 mm.

Clause 10. The method of clause 8, wherein a range of rotation in the rotational degrees of freedom is between 1 degree and 15 degrees.

Clause 11. The method of clause 1, wherein the final set of degrees of freedom include a retention degree of freedom along the z-axis of the tooth for intrusion.

Clause 12. The method of clause 11, wherein the final set of degrees of freedom include two activation degrees of freedom, including transition along the y-axis in a mesial-distal direction, and rotational about the x-axis, for angulation.

Clause 13. The method of clause 12, wherein final set of contact surfaces include a bubble and a pressure point.

Clause 14. The method of clause 13, wherein the bubble is located occlusal to the pressure point.

Clause 15. The method of clause 13, wherein the bubble extends away from a tooth receiving cavity of the appliance with a prominence of between 0.1 mm and 1.0 mm.

Clause 16. The method of clause 13, wherein the pressure point extends into a tooth receiving cavity of the appliance with a prominence of between 0.1 mm and 1.0 mm.

Clause 17. The method of clause 13, wherein the width of the contact surface is between 20% and 80% of the tooth width.

Clause 18. The method of clause 13, wherein the length of the contact surface is between 20% and 80% of the tooth length.

Clause 19. The method of clause 11, wherein the range of the retention degree of freedom is between 0.05 mm and 1 mm.

Clause 20. The method of clause 1, further comprising fabricating the aligner based on the contact surfaces.

Clause 21. A system for generating orthodontic aligner shapes, the system comprising: one or more processors and memory comprising instructions that when executed by the one or more processors, causes the system to carry out the method comprising: determining a desired force system for moving a tooth; generating a population of sets of degrees of freedom and contact surfaces; determining a force system for each of the sets in the population evaluating a cost function of each of the force systems compared to the desired force system; updating the population of sets of degrees of freedom and contact surfaces based on the cost function of each of the force systems; and repeating (c) through (e) until the determined force system for one of the sets matches the desired force system, to generate a final set of degrees of freedom and contact surfaces.

Clause 22. The system of clause 21, wherein the force system is based on a movement of a tooth in a stage of an orthodontic treatment plan.

Clause 23. The system of clause 22, wherein the movement is rotation.

Clause 24. The system of clause 22, wherein the movement is translation.

Clause 25. The system of clause 21, wherein the degrees of freedom are activation degrees of freedom.

Clause 26. The system of clause 25, wherein the degrees of freedom are retention degrees of freedom.

Clause 27. The system of clause 26, wherein the degrees of freedom for retention are different than the degrees of freedom for retention.

Clause 28. The system of clause 27, wherein the degrees of freedom are selected from three rotational degrees of freedom about three orthogonal axis and three translations degrees of freedom along the three orthogonal axis.

Clause 29. The system of clause 28, wherein a range of translation in the translation degrees of freedom is between 0.05 mm and 1 mm.

Clause 30. The system of clause 28, wherein a range of rotation in the rotational degrees of freedom is between 1 degree and 15 degrees.

Clause 31. The system of clause 21, wherein the final set of degrees of freedom include a retention degree of freedom along the z-axis of the tooth for intrusion.

Clause 32. The system of clause 31, wherein the final set of degrees of freedom include two activation degrees of freedom, including transition along the y-axis in a mesial-distal direction, and rotational about the x-axis, for angulation.

Clause 33. The system of clause 32, wherein final set of contact surfaces include a bubble and a pressure point.

Clause 34. The system of clause 33, wherein the bubble is located occlusal to the pressure point.

Clause 35. The system of clause 33, wherein the bubble extends away from a tooth receiving cavity of the appliance with a prominence of between 0.1 mm and 1.0 mm.

Clause 36. The system of clause 33, wherein the pressure point extends into a tooth receiving cavity of the appliance with a prominence of between 0.1 mm and 1.0 mm.

Clause 37. The system of clause 33, wherein the width of the contact surface is between 20% and 80% of the tooth width.

Clause 38. The system of clause 33, wherein the length of the contact surface is between 20% and 80% of the tooth length.

Clause 39. The system of clause 31, wherein the range of the retention degree of freedom is between 0.05 mm and 1 mm.

Clause 40. The system of clause 21, wherein the method further comprises fabricating the aligner based on the contact surfaces.

What is claimed is:

1. A system for generating orthodontic aligner shapes, the system comprising:
one or more processors and memory comprising instructions that when executed by the one or more processors, causes the system to carry out the method comprising:
(a) determining a desired force system for moving a tooth;
(b) generating a population of sets of degrees of freedom and contact surfaces;
(c) determining a force system for each of the sets in the population
(d) evaluating a cost function of each of the force systems compared to the desired force system;
(e) updating the population of sets of degrees of freedom and contact surfaces based on the cost function of each of the force systems; and
(f) repeating (c) through (e) until the determined force system for one of the sets matches the desired force system, to generate a final set of degrees of freedom and contact surfaces.

2. The system of claim 1, wherein the force system is based on a movement of a tooth in a stage of an orthodontic treatment plan.

3. The system of claim 2, wherein the movement is rotation.

4. The system of claim 2, wherein the movement is translation.

5. The system of claim 1, wherein the degrees of freedom are activation degrees of freedom.

6. The system of claim 5, wherein the degrees of freedom are retention degrees of freedom.

7. The system of claim 6, wherein the degrees of freedom for retention are different than the degrees of freedom for retention.

8. The system of claim 7, wherein the degrees of freedom are selected from three rotational degrees of freedom about three orthogonal axis and three translations degrees of freedom along the three orthogonal axis.

9. The system of claim 8, wherein a range of translation in the translation degrees of freedom is between 0.05 mm and 1 mm.

10. The system of claim 8, wherein a range of rotation in the rotational degrees of freedom is between 1 degree and 15 degrees.

11. The system of claim 1, wherein the final set of degrees of freedom include a retention degree of freedom along the z-axis of the tooth for intrusion.

12. The system of claim 11, wherein the final set of degrees of freedom include two activation degrees of freedom, including transition along the y-axis in a mesial-distal direction, and rotational about the x-axis, for angulation.

13. The system of claim 12, wherein final set of contact surfaces include a bubble and a pressure point.

14. The system of claim 13, wherein the bubble is located occlusal to the pressure point.

15. The system of claim 13, wherein the bubble extends away from a tooth receiving cavity of the appliance with a prominence of between 0.1 mm and 1.0 mm.

16. The system of claim 13, wherein the pressure point extends into a tooth receiving cavity of the appliance with a prominence of between 0.1 mm and 1.0 mm.

17. The system of claim 13, wherein the width of the contact surface is between 20% and 80% of the tooth width.

18. The system of claim 13, wherein the length of the contact surface is between 20% and 80% of the tooth length.

19. The system of claim 11, wherein the range of the retention degree of freedom is between 0.05 mm and 1 mm.

20. The system of claim 1, wherein the method further comprises fabricating the aligner based on the contact surfaces.
